(19) United States
(12) Patent Application Publication
(10) Pub. No.: US 2025/0343646 A1
(43) Pub. Date: Nov. 6, 2025

(54) WIRELESS COMMUNICATION METHOD, USER EQUIPMENT, NETWORK DEVICE AND STORAGE MEDIUM

(71) Applicant: Samsung Electronics Co., Ltd., Suwon-si, Gyeonggi-do (KR)

(72) Inventors: Zhe CHEN, Beijing (CN); Feifei SUN, Beijing (CN); He WANG, Beijing (CN)

(21) Appl. No.: 18/855,459

(22) PCT Filed: Apr. 14, 2023
(86) PCT No.: PCT/KR2023/005126

§ 371 Date: Oct. 9, 2024

(30) Foreign Application Priority Data
Apr. 15, 2022 (CN) 202210400125.8

(51) Int. Cl. H04L 5/00

(52) U.S. Cl. CPC H04L 5/0048

(57) ABSTRACT

The disclosure relates to a 5G or 6G communication system for supporting a higher data transmission rate. The present disclosure relates to a wireless communication method, a user equipment, a network device and a storage medium. The wireless communication method includes: receiving, by a user equipment, reference signal information from a network device, wherein the reference signal information comprises information related to a plurality of first reference signals; determining, by the user equipment, a parameter of a second reference signal according to the information related to the plurality of first reference signals.

### CROSS-REFERENCE TO RELATED APPLICATION(S)

This application is a U.S. National Stage application under 35 U.S.C. § 371 of an International application number PCT/KR2023/005126, filed on Apr. 14, 2023, which is based on and claims priority of a Chinese patent application number 202210400125.8, filed on Apr. 15, 2022, in the Chinese Intellectual Property Office, the disclosure of which is incorporated by reference herein in its entirety.

### TECHNICAL FIELD

The present application relates to the communication field, and in particular, to a wireless communication method, a user equipment, a network device and a storage medium.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz ” bands referred to as mmWave including 28 GHz and 39 GHz. In addition, it has been considered to implement 6G mobile communication technologies (referred to as Beyond SG systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE

### Technical Problem

The present disclosure provides a communication method for processing at least one reference signal.

### Solution to Problem

According to a first aspect of the present application, a wireless communication method is provided, the wireless communication method includes: receiving, by a user equipment, reference signal information from a network device, wherein the reference signal information includes information related to a plurality of first reference signals; determining, by the user equipment, a parameter of a second reference signal according to the information related to the plurality of first reference signals.

Alternatively, types of the plurality of first reference signals are same or different.

Alternatively, the information related to the plurality of first reference signals includes one or more transmission configuration indication (TCI) states.

Alternatively, the determining the parameter of the second reference signal includes: determining, by the user equipment, the parameter of the second reference signal according to a correlation between the first reference signal and the second reference signal.

Alternatively, correlations between each of the plurality of first reference signals and the second reference signal are same; or the correlation between the first reference signal and the second reference signal is related to an order of the first reference signal and/or a weight of the first reference signal.

Alternatively, the wireless communication method further includes: receiving an indication of weights of the plurality of first reference signals, wherein the weight is related to a correlation between the first reference signal and the second reference signal.

Alternatively, the correlation includes a spatial domain correlation or a spatial frequency domain correlation.

Alternatively, the determining, by the user equipment, the parameter of the second reference signal according to the correlation between the first reference signal and the second reference signal includes: determining, by the user equipment, the parameter of the second reference signal according to a spatial domain correlation or a spatial frequency domain correlation between the first reference signal and the second reference signal, based on a first indication information about the spatial domain correlation or the spatial frequency domain correlation transmitted by the network device; or determining, by the user equipment, the parameter of the second reference signal according to the spatial domain correlation between the first reference signal and the second reference signal; or determining, by the user equipment, the parameter of the second reference signal according to the spatial frequency domain correlation between the first reference signal and the second reference signal.

Alternatively, the wireless communication method further includes: receiving an indication of frequency domain information of the first reference signal and/or frequency domain information of the second reference signal, wherein the correlation is related to the frequency domain information of the first reference signal and/or the frequency domain information of the second reference signal.

Alternatively, the determining the parameter of the second reference signal includes: determining at least one first reference signal according to information of the plurality of first reference signals, determining the parameter of the second reference signal according to the at least one first reference signal.

Alternatively, the user equipment determines the parameter of the second reference signal according to a part of the plurality of first reference signals based on a first condition.

Alternatively, the first condition includes at least one of: the user equipment does not have a capability to determine the parameter of the second reference signal according to the plurality of first reference signals; the user equipment supports determining the parameter of the second reference signal according to a first number of first reference signals at most, wherein the first number is less than the number of the plurality of first reference signals; a scenario where the user equipment is located is different from a scenario applicable for determining the second reference signal according to the plurality of first reference signals; a measured value of a parameter of a reference signal determined by the user equipment according to the plurality of first reference signals is lower than a measured value of the parameter of the reference signal determined according to one of the plurality of first reference signals.

Alternatively, the part of the plurality of first reference signals is a part of first reference signals determined according to an order and/or measured values of the plurality of first reference signals.

Alternatively, the determining the parameter of the second reference signal includes: determining the parameter of the second reference signal by using an artificial intelligence model.

According to a second aspect of the present application, a wireless communication method is provided, the wireless communication method includes: transmitting, by a network device, reference signal information to a user equipment, wherein the reference signal information includes information related to a plurality of first reference signals, wherein, the information related to the plurality of first reference signals is used for the user equipment to determine a parameter of a second reference signal.

Alternatively, types of the plurality of first reference signals are same or different.

Alternatively, the information related to the plurality of first reference signals includes one or more transmission configuration indication (TCI) states.

Alternatively, the information related to the plurality of first reference signals is used for the user equipment to determine the parameter of the second reference signal according to a correlation between the first reference signal and the second reference signal.

Alternatively, correlations between each of the plurality of first reference signals and the second reference signal are same; or the correlation between the first reference signal and the second reference signal is related to an order of the first reference signal and/or a weight of the first reference signal.

Alternatively, the wireless communication method further includes: transmitting an indication of weights of the plurality of first reference signals to the user equipment, wherein the weight is related to a correlation between the first reference signal and the second reference signal.

Alternatively, the correlation includes a spatial domain correlation or a spatial frequency domain correlation.

Alternatively, the wireless communication method further includes: transmitting a first indication information about a spatial domain correlation or a spatial frequency domain correlation to the user equipment, wherein the first indication information is used to indicate the user equipment to determine the parameter of the second reference signal according to the spatial domain correlation or the spatial frequency domain correlation between the first reference signal and the second reference signal

Alternatively, the wireless communication method further includes: transmitting an indication of frequency domain information of the first reference signal and/or frequency domain information of the second reference signal to the user equipment, wherein the correlation is related to the frequency domain information of the first reference signal and/or the frequency domain information of the second reference signal.

Alternatively, the information related to the plurality of first reference signals is used for the user equipment to determine the parameter of the second reference signal according to at least one first reference signal of the plurality of first reference signals.

Alternatively, the at least one first reference signal is a part of the plurality of first reference signals determined according to an order and/or measured values of the plurality of first reference signals.

Alternatively, the information related to the plurality of first reference signals is used for the user equipment to determine the parameter of the second reference signal by using an artificial intelligence model.

According to a third aspect of the present application, a user equipment is provided, the user equipment includes: a transceiver; at least one processor coupled to the transceiver and configured to perform the above wireless communication method.

According to a fourth aspect of the present application, a network device is provided, the network device includes: a transceiver; at least one processor coupled to the transceiver and configured to perform the above wireless communication method.

According to a fifth aspect of the present application, there is provided a computer readable storage medium storing instructions that, when executed by at least one processor, cause the at least one processor to perform the above wireless communication method.

The technical solutions provided by the embodiments of the disclosure have at least the following beneficial effects: according to the wireless communication method of the exemplary embodiment of the disclosure, since the user equipment may receive the reference signal information from the network device (the reference signal information includes the information related to the plurality of first reference signals) and determine the parameter of the second reference signal according to the information related to the plurality of first reference signals, the delay may be effectively avoided and the receiving performance may be improved.

It is to be understood that both the foregoing general description and the following detailed description are exemplary and explanatory only and are not restrictive of the present disclosure.

### Advantageous Effects of Invention

The present disclosure provides a wireless communication method, a user equipment, a network device, an electronic device and a storage medium, to process at least one reference signal efficiently.

### BRIEF DESCRIPTION OF DRAWINGS

The accompanying drawings, which are incorporated in and constitute a part of this specification, illustrate example embodiments consistent with the present disclosure, and together with the description, serve to explain the principles of the present disclosure and do not unduly limit the disclosure.

FIG. 1 is an example wireless network 100 according to various embodiments of the present disclosure

FIGS. 2A and 2B illustrate example wireless transmission and reception paths according to the present disclosure.

FIG. 3A illustrates an example UE 116 according to the present disclosure.

FIG. 3B illustrates an example gNB 102 according to the present disclosure.

FIG. 4 is a flowchart of a wireless communication method performed by a user equipment according to an exemplary embodiment of the present disclosure.

FIG. 5 is a flowchart of a wireless communication method performed by a network device according to an exemplary embodiment of the present disclosure.

FIG. 6 is a block diagram of a user equipment according to an exemplary embodiment of the present disclosure.

FIG. 7 is a block diagram of a network device according to an exemplary embodiment of the present disclosure.

### MODE FOR THE INVENTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

The exemplary embodiments of the disclosure are further described below in conjunction with the attached drawings. The text and accompanying images are provided as examples only to help readers understand the disclosure. They are not intended and should not be construed as limiting the scope of the disclosure in any way. Although certain embodiments and examples have been provided, based on the content disclosed herein, it is obvious to those skilled in the field that the embodiments and examples shown may be changed without departing from the scope of the disclosure.

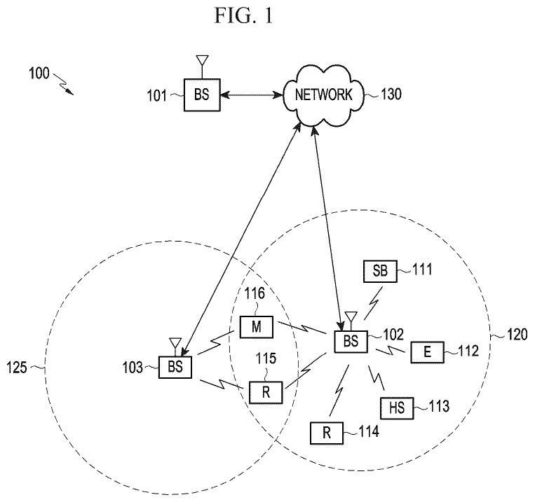

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support beambook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

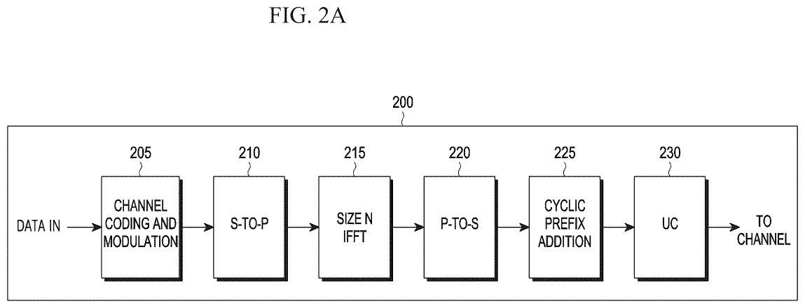

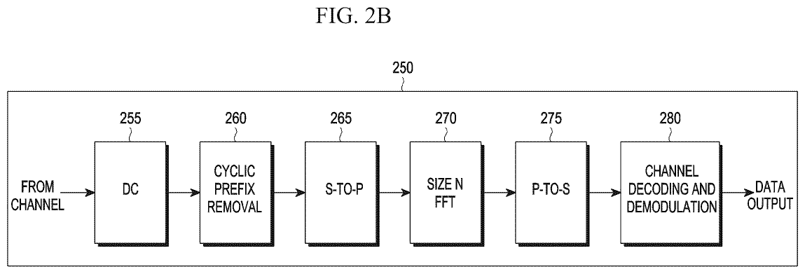

FIGS. 2A and 2B illustrate example wireless transmission and reception paths according to the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support beambook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

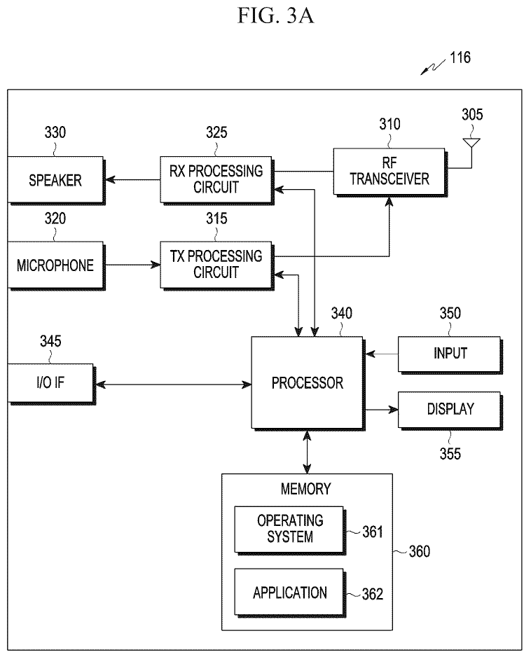

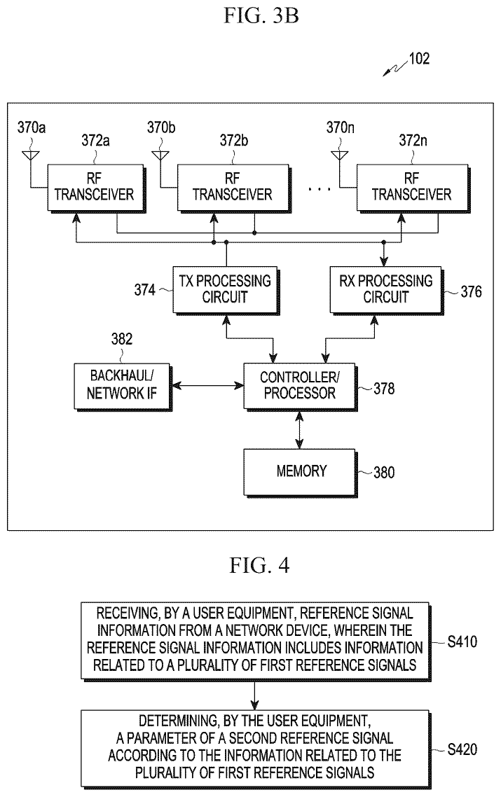

FIG. 3A illustrates an example UE 116 according to the present disclosure. The embodiment of UE 116 shown in FIG. 3A is for illustration only, and UEs 111-115 of FIG. 1 can have the same or similar configuration. However, a UE has various configurations, and FIG. 3A does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O)) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3a illustrates that the UE 116 is configured as a mobile phone or a smart phone, UEs can be configured to operate as other types of mobile or fixed devices.

FIG. 3B illustrates an example gNB 102 according to the present disclosure. The embodiment of gNB 102 shown in FIG. 3B is for illustration only, and other gNBs of FIG. 1 can have the same or similar configuration. However, a gNB has various configurations, and FIG. 3B does not limit the scope of the present disclosure to any specific implementation of a gNB. It should be noted that gNB 101 and gNB 103 can include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

The exemplary embodiments of the present disclosure are further described below in conjunction with the accompanying drawings. The text and drawings are provided as examples only to help readers understand the present disclosure. They are not intended and should not be interpreted as limiting the scope of the present disclosure in any way. Although certain embodiments and examples have been provided, based on the content disclosed herein, it is obvious to those skilled in the art that modifications to the illustrated embodiments and examples can be made without departing from the scope of the present disclosure.

In order to enhance the performance of the wireless communication system in high carrier frequency scenarios (e.g., FR2), the NR wireless communication system introduces a beam management mechanism for analog beamforming. Generally, the beam management mechanism is based on the measurement and reporting of the reference signal by the user equipment. Multiple reference signals (each corresponding to one beam) may be measured by the user equipment in order to determine the beam used by the user equipment to receive the reference signal. For example, according to the measured RSRP (Reference Signal Receiving Power) or L1-SINR (L1-Signal to Interference plus Noise Ratio), up to four optimal measurements (for example, four reference signals of the largest RSRP) may be reported to the base station. When the base station receives the report from the user equipment, it may select, according to the measurement results, a beam corresponding to one of the reference signals (for example, the maximum RSRP) for downlink transmission. In other words, the user equipment may receive the corresponding downlink transmission (DL transmission) from the base station according to the receiving beam corresponding to the previously determined reference signal. This approach is unfavorable to the overhead and delay of beam management. The reason is that if the base station has not sent a reference signal in a beam direction, the user equipment cannot determine the corresponding receiving beam in this beam direction because there is no reference signal information. Therefore, in this new beam direction, the base station must send the reference signals several times in advance to ensure that the user equipment may perform the receiving in the corresponding direction. This results in a higher delay of beam indication.

In order to reduce this delay, this patent provides a wireless communication method. In this wireless communication method, the network device may transmit information related to a plurality of reference signal to the user equipment, and the user equipment may determine a parameter of a new reference signal transmitted by the network device by using the information related to the plurality of reference signals. For example, the beams corresponding to the plurality of reference signals may have a correlation (for example, a spatial domain correlation, also known as a spatial correlation) with a new beam indicated by the base station. The user equipment may use receiving beam information of the measured plurality of reference signals to determine the receiving parameter corresponding to the new beam transmitted by the network device. Therefore, the delay caused by the new beam measurement is avoided and the system performance is improved.

FIG. 4 is a flowchart of a wireless communication method performed by a user equipment according to an exemplary embodiment of the present disclosure.

Referring to FIG. 4, in step S410, the user equipment receives reference signal information from a network device. The reference signal information includes information related to a plurality of first reference signals. For example, the information related to the plurality of first reference signals may include an indication of the plurality of first reference signals. The first reference signal may also be termed as a source reference signal. According to an exemplary embodiment, the information related to the plurality of first reference signals may include one or more transmission configuration indication (TCI) states. According to an exemplary embodiment, the plurality of first reference signals may correspond to one or more TCI states. The TCI state may be further classified as a DL TCI state, an UL TCI state or a joint TCI state, which are collectively referred to as a TCI state in this patent. The first reference signal may be one or a combination of the following reference signals: a synchronous signal block (SSB), a channel state information reference signal (CSI-RS), a positioning reference signal (PRS), and a sounding reference signal (SRS). These reference signals may be periodic, semi-continuous or aperiodic. For the CSI-RS, this reference signal may be a tracking reference signal (TRS, i.e., configured with trs-Info); this reference signal also be a CSI-RS for beam management (i.e., configured without trs-Info but configured with repetition); this reference signal may also be a CSI-RS for CSI acquisition (configured without trs-Info and configured without repetition). For the SRS, this reference signal may be an SRS for beam management (the corresponding ‘usage’ thereof is configured as ‘beam management’); this reference signal may be an SRS for codebook-based PUSCH transmission (the corresponding ‘usage’ thereof is configured as ‘codebook’); this reference signal can be an SRS for non-codebook-based PUSCH transmission (the corresponding ‘usage’ thereof is configured as ‘nonCodebook’); this reference signal may be an SRS for antenna switching (the corresponding ‘usage’ thereof is configured as ‘antennaSwitching’). Specifically, for example, the reference signal information may be implemented by example as follows:

### Method 1

The reference signal information may be TCI state information. For example, the information related to the plurality of first reference signals is multiple TCI state information. For example, the TCI state information may include an indication of a Quasi-Colocation (QCL) type and corresponding plurality of first reference signals. The QCL type may be one or a combination of the following parameters: a Doppler shift, a Doppler spread, an average delay, a delay spread, a Spatial Rx parameter, a Spatial Tx parameter, a Spatial parameter, a Spatial receive filter, a Spatial Tx filter, a Spatial filter. As an example, the QCL type may include QCL type A, QCL type B, QCL type C, QCL type D and QCL type E, etc. For example, the QCL type A may be {the Doppler shift, the Doppler spread, the average delay, the delay spread}. The QCL type B may be {the Doppler shift, the Doppler spread}, the QCL type C may be {the Doppler shift, the average delay}, the QCL type D may be the Spatial Rx parameter, and the QCL type E may be the Spatial parameter. The following takes the QCL type as the QCL type D (that is, the Spatial Rx parameter) for description.

According to an exemplary embodiment, the plurality of first reference signals are of the same type. For example, one implementation may be that the parameters of the QCL type D indicated by the TCI state are all associated with SSB. For example, QCL type D reference signals corresponding to TCI #1 (indicating one TCI state) are SSB #1, SSB #2, SSB #3, SSB #4. Another implementation may be that the parameters of the QCL type D indicated by the TCI state are all related to CSI-RS. For example, the QCL type D reference signal corresponding to TCI #1 is CSI-RS #1, CSI-RS #2, CSI-RS #3, and CSI-RS #4. Here, the CSI-RS may be the CSI-RS for beam management.

Alternatively, the plurality of first reference signals are of different types. For example, one implementation is that the parameters of the QCL type D indicated by the TCI state are related to SSB and CSI-RS. For example, the QCL type D reference signal corresponding to TCI #1 is SSB #1, SSB #2, CSI-RS #1, CSI-RS #2. Here, the CSI-RS may be the CSI-RS for beam management.

### Method 2

The reference signal information is information of multiple TCI states. For example, the information related to the plurality of first reference signals is information of multiple TCI states. Each TCI state information may include an indication of a QCL type and a corresponding first reference signal. The description of the QCL type and the first reference signal can refer to the previous description. The reference signal information including an indication of a plurality of first reference signals may mean that the same QCL type of multiple TCI states correspond to the plurality of first reference signals. For example, the QCL type D parameter of TCI #1 corresponds to SSB #1; the QCL type D parameter of TCI #2 corresponds to SSB #2; the QCL type D parameter of TCI #3 corresponds to SSB #3; the QCL type D parameter of TCH #4 corresponds to SSB #4. In this way, it may be understood that the reference signal information is associated with SSB #1, SSB #2, SSB #3 and SSB #4, or that the reference signal information includes the indication of SSB #1, SSB #2, SSB #3 and SSB #4

According to an exemplary embodiment, the plurality of first reference signals correspond to the same type of reference signals. For example, one implementation may be that the QCL type D parameters indicated by these TCI states are all related to the SSB. For example, the QCL type D reference signals corresponding to these TCI states (TCH #1, TCI #2, TCI #3, TCI #4) are SSB #1, SSB #2, SSB #3, SSB #4. Another implementation is that the QCL type D parameters indicated by these TCI states are all related to the CSI-RS. For example, the QCL type D reference signals corresponding to these TCI states (TCI #1, TCI #2, TCI #3, TCI #4) are CSI-RS #1, CSI-RS #2, CSI-RS #3, CSI-RS #4. Here, the CSI-RS may be the CSI-RS for beam management.

Alternatively, the types of the plurality of first reference signals are of different types. One implementation is that the QCL type D parameters indicated by these TCI states are related to the SSB and the CSI-RS. For example, the QCL type D reference signals corresponding to these TCI states (TCI #1, TCI #2, TCH #3, TCI #4) are SSB #1, SSB #2, CSI-RS #1, CSI-RS #2. Here, the CSI-RS may be the CSI-RS for beam management.

After receiving the above reference signal information, in step S420, the user equipment determines a parameter of a second reference signal based on the information related to the plurality of first reference signals. The second reference signal may be termed as target reference signal. As an example, the determining of the parameter of the second reference signal may include: determining at least one first reference signal according to the information of the plurality of first reference signals; determining the parameter of the second reference signal according to the at least one first reference signal.

Since the user equipment receives the reference signal information from the network device, and the reference signal information includes the information related to the plurality of first reference signals (for example, the indication of the plurality of first reference signals), the user equipment may determine the corresponding plurality of first reference signals through the received reference signal information. According to an exemplary embodiment, the plurality of first reference signals may be related to the second reference signal. The user equipment may determine the parameter of the second reference signal based on a correlation between the first reference signal and the second reference signal. The correlation may be a spatial domain correlation or a spatial frequency domain correlation.

As an example, the second reference signal may be a CSI-RS for tracking, a CSI-RS for beam management, a CSI-RS for CSI acquisition, a demodulation reference signal (DM-RS) of a Physical Downlink Control Channel (PDCCH), a DM-RS of a Physical Downlink Shared Channel (PDSCH), a DM-RS of a Physical Uplink Shared Channel (PUSCH), an SRS for PUSCH transmission, and a SRS for beam management, etc. Here, the parameter of the second reference signal may be either a receiving parameter of the second reference signal or a transmitting parameter of the second reference signal. For example, the parameter of the second reference signal may be one or a combination of the following parameters: a Doppler shift, a Doppler spread, an average delay, a delay spread, a Spatial Rx parameter, a Spatial Tx parameter, a Spatial parameter, a Spatial Rx filter, a Spatial Tx filter, a Spatial filter. The following takes the parameter of the second reference signal as a QCL type D parameter for example.

For example, the plurality of first reference signals correspond to one TCI state, the plurality of first reference signals are the SSBs, the corresponding parameters of the plurality of reference signals are the QCL type D (Spatial Rx parameters), and the second reference signal is the DM-RS of PDSCH. Specifically, for example, one TCI state corresponding to the plurality of first reference signals is TCI #1, TCI #1 may include four QCL type D reference signals (SSB #1, SSB #2, SSB #3, SSB #4). The DM-RS of PDSCH is associated with TCI #1 if the plurality of first reference signals are associated with the second reference signal and the plurality of first reference signals correspond to one TCI state. It may also be said that the QCL type D parameter of the DM-RS port of PDSCH is related to the QCL type D parameters of SSB #1, SSB #2, SSB #3 and SSB #4 indicated in TCI #1; in other words, the DM-RS port of PDSCH is related to SSB #1, SSB #2, SSB #3 and SSB #4 indicated in TCI #1 with respect to the QCL type D (Spatial Rx parameter); in other words, the DM-RS port of PDSCH and SSB #1, SSB #2, SSB #3, SSB #4 indicated in TCI #1 are quasi co-located (QCL) with respect to the QCL type D (Spatial Rx parameter); in other words, the QCL type D parameter of the DM-RS port of PDSCH is determined according to the QCL type D (Spatial Rx parameters) of SSB #1, SSB #2, SSB #3 and SSB #4 indicated in TCI #1.

The correlation between the first reference signal and the second reference signal is further explained below. According to an exemplary embodiment, the correlations between each of the plurality of first reference signals and the second reference signal may be same; Alternatively, the correlation between the first reference signal and the second reference signal may be related to an order of the first reference signal and/or a weight of the first reference signal. For example, the order may be an order of an ID of the first reference signal (also referred to as an indication order hereafter) or an order in which the first reference signal is configured. In the case that the correlation between the first reference signal and the second reference signal is related to the weight of the first reference signal, the wireless communication method shown in FIG. 4 may also include, as an example, receiving an indication of weights of the plurality of first reference signals, where the weight is related to the correlation between the first reference signal and the second reference signal. For example, the weight may be a weight used to represent a spatial domain (or spatial frequency domain) correlation between the first reference signal and the second reference signal. As an example, the indication of the weights of the plurality of first reference signals may be included in the reference signal information above. Alternatively, the indication of the weights of the plurality of first reference signals may also be sent to the terminal equipment not via the reference signal information above.

With the reference of the above example, that is, the DM-RS port of PDSCH is related to SSB #1, SSB #2, SSB #3 and SSB #4 indicated in TCI #1 with respect to the QCL type D (Spatial Rx parameter). Specifically, for example, the correlations of them are in the following ways:
#1. The DM-RS of PDSCH has the same spatial domain correlation with each of the plurality of first reference signals (SSB #1, SSB #2, SSB #3, SSB #4); in other words, the DM-RS of PDSCH has the same correlation with each of the plurality of first reference signals (SSB #1, SSB #2, SSB #3, SSB #4) with respect to the QCL type D parameter. In other words, the DM-RS of PDSCH has the same correlation with each of the plurality of first reference signals (SSB #1, SSB #2, SSB #3, SSB #4) with respect to the QCL type E parameter.
#2. The correlations between the DM-RS of PDSCH and the plurality of first reference signals (SSB #1, SSB #2, SSB #3, SSB #4) are related to an indication order of the plurality of first reference signals. For example, the indication order is SSB #1, SSB #2, SSB #3, SSB #4; correspondingly, their spatial domain correlations are also ranked from high to low. In other words, the spatial domain correlation between the DM-RS of PDSCH and SSB #1 is the highest, followed by the spatial domain correlation between the DM-RS of PDSCH and SSB #2, further followed by the spatial domain correlation between the DM-RS of PDSCH and SSB #3, and the spatial domain correlation between the DM-RS of PDSCH and SSB #4 is the lowest.
3. The correlations between the DM-RS of PDSCH and the plurality of first reference signals (SSB #1, SSB #2, SSB #3, SSB #4) are related to weights of the plurality of first reference signals. For example, TCI #1 not only includes the indications of SSB #1, SSB #2, SSB #3, SSB #4, but also indicates the corresponding weights (values in parentheses). For example, SSB #1 (0.3), SSB #2 (0.6), SSB #3 (0.6), SSB #4 (0.9); the higher the weight is, the higher the spatial domain correlation is. In other words, the spatial domain correlation between the DM-RS of PDSCH and SSB #4 is the highest. The spatial domain correlation between the DM-RS of PDSCH and SSB #2 is the same as the spatial domain correlation between the DM-RS of PDSCH and SSB #3. The spatial domain correlation between the DM-RS of PDSCH and SSB #1 is the lowest. After the user equipment obtains the spatial domain correlations between the plurality of first reference signals and the second reference signal, the user equipment may determine the parameter of the second reference signal based on the spatial domain correlations. For example, when the user equipment obtains the above spatial domain correlations, the user equipment may determine the parameter of the second reference signal according to the plurality of first reference signals in the way of interpolation, but is not limited to this. For example, after the corresponding Spatial Rx parameters is obtained based on the measurement of the plurality of first reference signals, the parameter of the second reference signal is determined by spatial domain interpolation on the Spatial Rx parameters in the case of using the spatial domain correlation.

According to the method provided in the above exemplary embodiment, after receiving the information related to the plurality of first reference signals, the user equipment may determine the receiving parameter of the second reference signal according to the correlations between the plurality of first reference signals and the second reference signal, thereby improving the receiving performance of the user equipment (improving the accuracy of the receiving parameters).

In the above exemplary embodiment, the user equipment determines the parameter of the second reference signal by using the plurality of first reference signals. Alternatively, however, in some cases, the user equipment may determine the parameter of the second reference signal by using only a part of the plurality of first reference signals (through using the same method). For example, the user equipment determines the parameter of the second reference signal according to a part of plurality of the first reference signals, based on a first condition. For example, the part of the plurality of first reference signals may be a part of first reference signals determined according to an order and/or measured values of the plurality of first reference signals. For example, the part of the plurality of first reference signals may be a part of first reference signals which are the first among the ordering of the plurality of first reference signals, or the part of the plurality of first reference signals may be a part of first reference signals with the highest measured values among the plurality of first reference signals (e.g., the measured value may be the most recent measured value). For example, the measured value may be a reference signal receiving power (RSRP), a Layer 1 reference signal receiving power (L1-RSRP), or a Layer 1 reference signal receiving quality (L1-RSRQ). In addition, the first condition may include, for example, at least one of the following: the user equipment does not have a capability to determine the parameter of the second reference signal according to the plurality of first reference signals; the user equipment supports determining the parameter of the second reference signal according to a first number of first reference signals at most, wherein the first number is less than the number of the plurality of first reference signals; or a scenario where the user equipment is located is different from a scenario applicable for determining the second reference signal according to the plurality of first reference signals; or a measured value of a parameter of a reference signal (which may be the second reference signal or a reference signal of the same type as the first reference signal and/or the second reference signal) determined by the user equipment according to the plurality of first reference signals is lower than a measured value of the parameter of the reference signal (which may be the second reference signal or a reference signal of the same type as the first reference signal and/or the second reference signal) determined according to one of the plurality of first reference signals.

According to an exemplary embodiment, the method for determining the part of the plurality of first reference signals may be as follows:

### Method 1

The first condition is that the user equipment does not have the capability to determine the parameter of the second reference signal according to the plurality of first reference signals, for example, the user equipment does not have the capability to determine a QCL parameter of the second reference signal according to the plurality of first reference signals (that is, the QCL parameter may be determined based on only one first reference signal). Under this condition, the user equipment selects (determines) one first reference signal among the plurality of reference signals. This first reference signal may be selected according to the order, for example, it is the first reference signal which is the first among the ordering of the plurality of first reference signals; in addition, this first reference signal may be selected based on the (most recent) reference signal measurement, for example, it may be a reference signal with the highest (most recent) measured value (RSRP, L1-RSRP, or L1-RSRQ) among the plurality of first reference signals.

### Method 2

The first condition is that the user equipment supports determining the parameter of the second reference signal according to the first number of first reference signals at most, where the first number is less than the number of the plurality of first reference signals. For example, the number of the plurality of first reference signals is X, and the user equipment supports to determine the QCL parameter of the second reference signal at most according to Y first reference signals, where X is greater than Y. Under this condition, the user equipment may select Y first reference signals from the plurality of first reference signals. The Y reference signals may be selected according to the order, for example, the Y first reference signals is first reference signals which are first Y reference signals among the ordering of the plurality of first reference signals. Alternatively, the Y reference signals may be selected based on the (most recent) reference signal measurement, for example, they are Y first reference signal with the highest (most recent) measured value (RSRP, L1-RSRP, or L1-RSRQ, etc.) among the plurality of first reference signals.

### Method 3

The first condition is that the scenario where the user equipment is located is different from the scenario applicable for determining the second reference signal according to the plurality of first reference signals (for example, the scenario applicable for determining the second reference signal according to the plurality of first reference signals is “the moving speed of the user equipment is a low speed”, while the scenario determined via measurement (or other means) by the user equipment is “the moving speed of the user equipment is a high speed”; or the scenario applicable for determining the second reference signal according to the plurality of first reference signals is “the user equipment is indoors”, while the scenario determined via measurement (or other means) by the user equipment is “the user equipment is outdoors”). It should be noted that the scenario may be related to other information about the user equipment in addition to the speed and location of the user equipment, and the disclosure has no restriction on this. Under this condition, the user equipment may select (determine) one first reference signal among the plurality of first reference signals. This first reference signal may be selected according to the order, for example, it is the first among the ordering of the plurality of first reference signals; in addition, this first reference signal may be selected based on the (most recent) reference signal measurement, for example, it is a reference signal with the highest measured value (RSRP, L1-RSRP, or L1-RSRQ) among the plurality of first reference signals.

### Method 4

The first condition is that the measured value of the parameter of the reference signal determined by the user equipment based on the plurality of first reference signals is lower than the measured value of the parameter of the reference signal determined based on one of the plurality of first reference signals. Here, the reference signal in the statement “determine the parameter of the reference signal” may be the second reference signal or a reference signal of the same type as the first reference signal and/or the second reference signal. As an example, the measured value here may be a measured value obtained from the most recent determination of the parameter of the reference signal, or an average obtained from the recent N times (N greater than 1) of determining the parameter of the reference signal, and so on. This means that the estimation of the receiving beam by the terminal equipment based on multiple reference signals is not more accurate. Therefore, in this case, the terminal equipment falls back to using one reference signal to determine the receiving parameter. That is, under this condition, the user equipment may select (determine) one reference signal among the plurality of first reference signals. This first reference signal may be selected according to the order, for example, it is ranked first among the plurality of first reference signals; in addition, this first reference signal may be selected based on the (most recent) reference signal measurement, for example, it is a reference signal with the highest measured value (RSRP, L1-RSRP, or L1-RSRQ) among the plurality of first reference signals.

After determining the part of the plurality of first reference signals, the user equipment may use only this part of first reference signals to determine the parameter of the second reference signal in the same manner as determining the parameter of the second reference signal using the plurality of first reference signals.

In the above exemplary embodiment, the reference signal information includes the information related to the plurality of first reference signals, and the parameter of the second reference signal may be determined according to the correlation between the first reference signal and the second reference signal. According to another exemplary embodiment, alternatively, the wireless communication method shown in FIG. 4 may further include receiving an indication of frequency domain information of the first reference signal and/or frequency domain information of the second reference signal. The above correlation may be related to the frequency domain information of the first reference signal and/or the frequency domain information of the second reference signal. As an example, the indication of the frequency domain information of the first reference signal and/or the frequency domain information of the second reference signal may be included in the reference signal information, or the indication may also be sent to the terminal equipment in a manner not included in the reference signal information, and there is no limit to the manner of receiving the indication. The reason for indicating the frequency domain information is that the channel may have the selectivity in frequency domain. That is to say, one reference signal has different characteristics in different frequency domains, and the measurement results are different. The frequency domain information may include at least one of the following: frequency domain information related to a cell (Cell ID), frequency domain information related to a bandwidth portion (BWP ID), frequency domain information related to a subband (e.g., a subband of a carrier bandwidth), and frequency domain information related to a physical resource block (PRB) (e.g., start of the PRB and the number of consecutive PRBs). According to an exemplary embodiment, the plurality of first reference signals may have the same granularity in the frequency domain.

The following examples are used to further explain, and descriptions similar to the embodiments described earlier are not repeated. As mentioned above, the user equipment may receive the reference signal information from the network device. As an example, the reference signal information may include, in addition to the information related to the plurality of first reference signals, the indication of the frequency domain information of the plurality of first reference signals (referring to the explanation following the reference signal). For example, the reference signal information may be implemented as follows:

### Method 1

The reference signal information may be one TCI state information. The information related to the plurality of first reference signals may be one TCI state information. For example, this TCI state information may include an indication of a QCL type and a corresponding plurality of first reference signals. The following description takes that the QCL type is a QCL type D (i.e., Spatial Rx parameter) as an example.

According to an exemplary embodiment, the plurality of first reference signals may refer to a plurality of first reference signals corresponding to a same reference signal ID but corresponding to different frequency domain information. For example, one implementation is that the QCL type D parameters (QCL type D) indicated by the TCI state are all related to SSB #1. For example, the first reference signals of the QCL type D corresponding to TCI #1 are SSB #1 (frequency domain information #1), SSB #I (frequency domain information #2), SSB #1 (frequency domain information #3), and SSB #1 (frequency domain information #4). Another implementation may be that the QCL type D parameters (QCL type D) indicated by the TCI state are all related to the CSI-RS. For example, the first reference signals of the QCL type D corresponding to TCI #1 are CSI-RS #1 (frequency domain information #1), CSI-RS #1 (frequency domain information #2), CSI-RS #1 (frequency domain information #3), and CSI-RS #1 (frequency domain information #4). Here, the CSI-RS may be the CSI-RS for beam management.

Alternatively, the plurality of first reference signals are of the same type. For example, one implementation may be that the QCL type D parameters (QCL type D) indicated by the TCI state are all related to SSB. For example, the first reference signals of the QCL type D corresponding to TCI #1 are SSB #1 (frequency domain information #1), SSB #2 (frequency domain information #2), SSB #3 (frequency domain information #3) and SSB #4 (frequency domain information #4). Another implementation may be that the QCL type D parameters (QCL type D) indicated by the TCI state are all related to CSI-RS. For example, the first reference signals of the QCL type D corresponding to TCI #1 are CSI-RS #1 (frequency domain information #1), CSI-RS #2 (frequency domain information #2), CSI-RS #3 (frequency domain information #3), and CSI-RS #4 (frequency domain information #4). Here, the CSI-RS may be the CSI-RS for beam management.

Alternatively, the plurality of first reference signals are of different types. For example, one implementation is that the QCL type D parameters (QCL type D) indicated by the TCI state are all related to SSB and CSI-RS. For example, the first reference signals of the QCL type D corresponding to TCI #1 is SSB #1 (frequency domain information #1), SSB #2 (frequency domain information #2), CSI-RS #1 (frequency domain information #3), and CSI-RS #2 (frequency domain information #4). Here, CSI-RS may be CSI-RS for beam management.

### Method 2

The reference signal information is information of multiple TCI state. For example, the information related to the plurality of reference signals is information of multiple TCI state. Each TCI state information includes an indication of a QCL type and a corresponding first reference signal. The QCL type and the first reference signal are described in Method 1. The reference signal information including the indication of the plurality of first reference signals means that the same QCL type of multiple TCI states correspond to the plurality of first reference signals. For example, the QCL type D parameter of TCI #1 corresponds to SSB #1 (frequency domain information #1); the QCL type D parameter of TCI #2 corresponds to SSB #2 (frequency domain information #2); the QCL type D parameter of TCI #3 corresponds to SSB #3 (frequency domain information #3); the QCL type D parameter of TCI #4 corresponds to SSB #4 (frequency domain information #4). In this way, it may be understood that the reference signal information is associated with SSB #1, SSB #2, SSB #3 and SSB #4, or that the reference signal information includes the indication of SSB #1, SSB #2, SSB #3 and SSB #4.

According to an exemplary embodiment, the plurality of first reference signals may be a plurality of first reference signals corresponding to the same reference signal ID but corresponding to different frequency domain information. For example, one implementation may be that the QCL type D parameters (QCL type D) indicated by these TCI states are all related to SSB #1. For example, the QCL type D reference signals corresponding to these TCI states (TCI #1, TCI #2, TCI #3, TCI #4) are SSB #1 (frequency domain information #1), SSB #1 (frequency domain information #2), SSB #1 (frequency domain information #3), SSB #1 (frequency domain information #4). Alternatively, the QCL type D parameters (QCL type D) indicated by these TCI states are all related to the CSI-RS. For example, the QCL type D reference signals corresponding to these TCI states (TCI #1, TCI #2, TCI #3, TCI #4) are CSI-RS #1 (frequency domain information #1), CSI-RS #1 (frequency domain information #2), CSI-RS #1 (frequency domain information #3), CSI-RS #1 (frequency domain information #4). Here, the CSI-RS may be the CSI-RS for beam management.

Alternatively, the plurality of first reference signals are of the same type. For example, one implementation may be that the QCL type D parameters (QCL type D) indicated by these TCI states are all related to SSB. For example, the first reference signals of the QCL type D corresponding to these TCI states (TCI #1, TCI #2, TCI #3, TCI #4) are SSB #1 (frequency domain information #1), SSB #2 (frequency domain information #2), SSB #3 (frequency domain information #3), SSB #4 (frequency domain information #4). Alternatively, the QCL type D parameters (QCL type D) indicated by these TCI states are related to the CSI-RS. For example, the first reference signals of the QCL type D corresponding to these TCI states (TCI #1, TCH #2, TCH #3, TCI #4) are CSI-RS #1 (frequency domain information #1), CSI-RS #2 (frequency domain information #2), CSI-RS #3 (frequency domain information #3), CSI-RS #4 (frequency domain information #4). Here, the CSI-RS may be the CSI-RS for beam management.

Alternatively, the plurality of reference signals are of different types. For example, one implementation may be that the QCL type D parameters (QCL type D) indicated by these TCI states are related to the SSB and the CSI-RS. For example, the first reference signals of the QCL type D corresponding to these TCI states (TCI #1, TCI #2, TCI #3, TCI #4) are SSB #1 (frequency domain information #1), SSB #2 (frequency domain information #2), CSI-RS #1 (frequency domain information #3), CSI-RS #2 (frequency domain information #4). Here, the CSI-RS may be the CSI-RS for beam management.

As mentioned above, the user equipment may determine the parameter of the second reference signal according to at least one of the plurality of first reference signals. According to another exemplary embodiment, in addition to receiving the reference signal information, the user equipment may receive the indication of the frequency domain information. In this case, the user equipment determines the corresponding plurality of reference signals by receiving the reference information and determines the frequency domain information corresponding to these reference signals according to the instruction of the frequency domain information. The plurality of first reference signals may be related to the second reference signal. In this case, the user equipment may determine the parameter of the second reference signal based on the correlation between the first reference signal and the second reference signal. In the following description, it is assumed that the plurality of first reference signals correspond to one TCI state, the plurality of first reference signals are SSBs, the corresponding parameters of the plurality of first reference signals are the QCL type D (Spatial Rx parameters), and the second reference signal is the DM-RS of PDSCH, the parameter of the second reference signal is the QCL type D parameter. Specifically, for example, if one TCI state corresponding to the plurality of first reference signals is TCI #1, then TCI #1 may include four QCL type D reference signals (SSB #1, SSB #2, SSB #3, SSB #4). The DM-RS of PDSCH is associated with TCI #1 when the plurality of first reference signals are associated with the second reference signal and the plurality of first reference signals correspond to one TCI state. In other words, the QCL type D parameter of the DM-RS port of PDSCH is related to the QCL type D parameters of SSB #1 (frequency domain information #1), SSB #2 (frequency domain information #2), SSB #3 (frequency domain information #3) and SSB #4 (frequency domain information #4) indicated in TCI #1. In other words, the DM-RS port of PDSCH is related to SSB #1 (frequency domain information #1), SSB #2 (frequency domain information #2), SSB #3 (frequency domain information #3), SSB #4 (frequency domain information #4) indicated in TCI #1 with respect to the QCL type D (Spatial Rx parameter). It may also be said that the DM-RS port of PDSCH and SSB #1 (frequency domain information #1), SSB #2 (frequency domain information #2), SSB #3 (frequency domain information #3), SSB #4 (frequency domain information #1) indicated in TCI #1 are quasi co-located (QCL) with respect to the QCL type D (Spatial Rx parameter); It may also be said that the QCL type D parameter of the DM-RS port of PDSCH is determined according to the QCL type D (Spatial Rx parameters) of SSB #1 (frequency domain information #1), SSB #2 (frequency domain information #2), SSB #3 (frequency domain information #3), SSB #4 (frequency domain information #4) indicated in TCI #1.

The correlations between the plurality of first reference signals and the second reference signal are further explained below. The above example is continued to use, that is, the DM-RS port of PDSCH is related to SSB #1, SSB #2, SSB #3, SSB #4 indicated in TCI #1 with respect to the QCL type D (Spatial Rx parameter). Specifically, for example, their correlations may be the following two schemes:

Scheme 1: the correlation is the spatial domain correlation
#1. The DM-RS of PDSCH has the same spatial domain correlation with each of the plurality of first reference signals (SSB #1, SSB #2, SSB #3, SSB #4); in other words, the DM-RS of PDSCH has the same correlation with each of the plurality of first reference signals (SSB #1, SSB #2, SSB #3, SSB #4) with respect to the QCL type D parameter. In other words, the DM-RS of PDSCH has the same correlation with each of the plurality of first reference signals (SSB #1, SSB #2, SSB #3, SSB #4) with respect to the QCL type E parameter.
#2. The correlations between the DM-RS of PDSCH and the plurality of first reference signals (SSB #1, SSB #2, SSB #3, SSB #4) are related to an indication order of the plurality of first reference signals. For example, the indication order is SSB #1, SSB #2, SSB #3, SSB #4; correspondingly, their spatial domain correlations are also ranked from high to low. In other words, the spatial domain correlation between the DM-RS of PDSCH and SSB #1 is the highest, followed by the spatial domain correlation between the DM-RS of PDSCH and SSB #2, further followed by the spatial domain correlation between the DM-RS of PDSCH and SSB #3, and the spatial domain correlation between the DM-RS of PDSCH and SSB #4 is the lowest.
#3. The correlations between the DM-RS of PDSCH and the plurality of first reference signals (SSB #1, SSB #2, SSB #3, SSB #4) are related to weights of the plurality of first reference signals. For example, TCI #1 not only includes the indications of SSB #1, SSB #2, SSB #3, SSB #4, but also indicates the corresponding weights (values in parentheses). For example, SSB #1 (0.3), SSB #2 (0.6), SSB #3 (0.6), SSB #4 (0.9); the higher the weight is, the higher the spatial domain correlation is. In other words, the spatial domain correlation between the DM-RS of PDSCH and SSB #4 is the highest. The spatial domain correlation between the DM-RS of PDSCH and SSB #2 is the same as the spatial domain correlation between the DM-RS of PDSCH and SSB #3. The spatial domain correlation between the DM-RS of PDSCH and SSB #1 is the lowest.

Scheme 2: the correlation is the spatial frequency domain correlation. In other words, the correlation also needs to consider frequency domain information, SSB #1 corresponds to frequency domain resource #1, SSB #2 corresponds to frequency domain resource #2, SSB #3 corresponds to frequency domain resource #3, SSB #4 corresponds to frequency domain resource #4, and the DM-RS of PDSCH corresponds to frequency domain resource #5.
#1. The DM-RS of PDSCH has the same spatial frequency domain correlation with each of the plurality of first reference signals (SSB #1, SSB #2, SSB #3, SSB #4).
#2. The spatial frequency domain correlations between the DM-RS of PDSCH and the plurality of first reference signals (SSB #1, SSB #2, SSB #3, SSB #4) are related to the indication order of the plurality of first reference signals. For example, the indication order is SSB #1, SSB #2, SSB #3, SSB #4; correspondingly, their spatial frequency domain correlations are ranked also from high to low. In other words, the spatial frequency domain correlation between the DM-RS of PDSCH and SSB #1 is the highest, followed by the spatial frequency domain correlation between the DM-RS of PDSCH and SSB #2, further followed by the spatial frequency domain correlation between the DM-RS of PDSCH and SSB #3, and the spatial frequency domain correlation between the DM-RS of PDSCH and SSB #4 is the lowest.
#3. The spatial frequency domain correlations between the DM-RS of PDSCH and the plurality of first reference signals (SSB #1, SSB #2, SSB #3, SSB #4) are related to corresponding weights of the plurality of first reference signals. For example, TCI #1 not only includes the indications of SSB #1, SSB #2, SSB #3, SSB #4, but also indicates the corresponding weights (values in parentheses). For example, SSB #1 (0.3), SSB #2 (0.6), SSB #3 (0.6), SSB #4 (0.9); the higher the weight is, the higher the spatial frequency domain correlation is. In other words, the spatial frequency domain correlation between the DM-RS of PDSCH and SSB #4 is the highest. The spatial frequency domain correlation between the DM-RS of PDSCH and SSB #2 is the same as the spatial frequency domain correlation between the DM-RS of PDSCH and SSB #3. The spatial frequency domain correlation between the DM-RS of PDSCH and SSB #1 is the lowest.

After the user equipment obtains the above information, a way in which the user equipment determines the parameter of the second reference signal according to the plurality of first reference signals may be interpolation, but is not limited to this.

For Scheme 1, after the corresponding Spatial Rx parameters is obtained based on the measurement of the plurality of first reference signals, the parameter of the second reference signal may be determined by spatial domain interpolation based on these Spatial Rx parameters using the spatial frequency domain correlation.

For Scheme 2, after the corresponding Spatial Rx parameters is obtained based on the measurement of the plurality of first reference signals, the parameter of the second reference signal may be determined by spatial frequency domain interpolation (that is, 2D (2-dimension) interpolation) based on these Spatial Rx parameters and the corresponding frequency domain information using the spatial frequency domain correlation.

### Scheme 3

Scheme 3 is a variation of Scheme 1. Similar to Scheme 1, the terminal equipment first obtains the corresponding Spatial Rx parameters according to the measurement of the plurality of first reference signals. The terminal equipment obtains the corresponding Spatial Rx parameters according to these measurements, and derives (determines) the Spatial Rx parameters (adjusted value) corresponding to the plurality of first reference signals, in the frequency domain location/range (for example, CC) of the second reference signal according to the frequency domain relationship between the frequency domain information of the second reference signal and the plurality of first reference signals. According to the adjusted results (i.e., considering the frequency domain characteristics), the terminal equipment further performs spatial frequency domain interpolation according to the spatial domain correlation to determine the parameter of the second reference signal.

In the above examples, the user equipment determines the parameter of the first reference signal using the plurality of first reference signals to. However, in some cases, the user equipment may also determine the parameter of the second reference signal using only a part of the plurality of first reference signals (using the same method). The specific determination method refers to the above embodiment of using the plurality of first reference signals, which will not be repeated here.

For the above three schemes (i.e., Scheme 1, Scheme 2, and Scheme 3), the network device may instruct the user equipment which scheme to use (or instruct whether the user equipment considers the frequency domain correlation) by indication information. Alternatively, if the user equipment does not receive the indication information, Scheme 1 is used by default (without considering the frequency domain correlation).

For example, when the user equipment determines the parameter of the second reference signal according to the correlation between the first reference signal and the second reference signal, the user equipment determines the parameter of the second reference signal according to the spatial domain correlation or spatial frequency domain correlation between the first reference signal and the second reference signal based on the first indication information about the spatial domain correlation or spatial frequency domain correlation sent by the network device. Alternatively, the user equipment may determine the parameter of the second reference signal by default based on the spatial domain correlation between the first reference signal and the second reference signal, or determine the parameter of the second reference signal based on the spatial frequency domain correlation between the first reference signal and the second reference signal. Alternatively, if the user equipment does not receive the first indication information from the network device, the user equipment may determine the parameter of the second reference signal according to the spatial domain correlation between the first reference signal and the second reference signal.

According to the various exemplary embodiments described above, the user equipment may determine the parameter of the second reference signal by using an AI model (AI algorithm, machine learning model, machine learning algorithm). The AI model may be pre-trained to predict the parameter of the second reference signal based on the information related to the plurality of first reference signals. The invention is not limited to the AI model adopted, and may also be realized in a non-artificial intelligence way to determine the parameter of the second reference signal based on the information related to the plurality of first reference signals.

In the above, the wireless communication method performed by the user equipment according to the embodiments of the disclosure has been described with reference to FIG. 4. According to the wireless communication method, since the user equipment may receive the reference signal information from the network device (the reference signal information includes the information related to the plurality of first reference signals), determine the parameter of the second reference signal according to the information related to the plurality of first reference signals, which may effectively avoid the delay and improve the receiving performance.

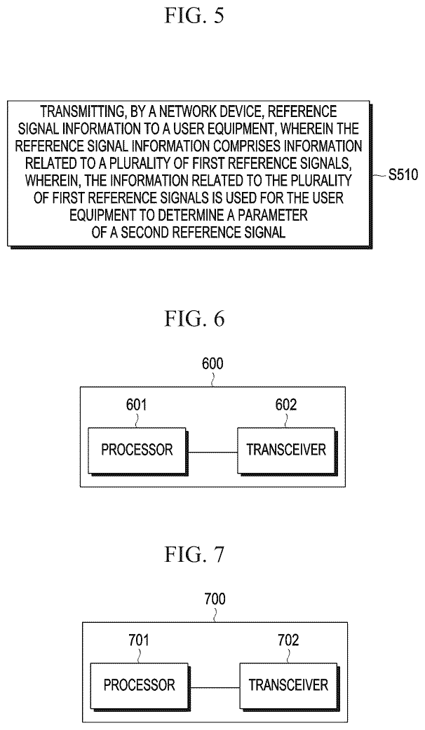

FIG. 5 is a flowchart of a wireless communication method performed by a network device according to an exemplary embodiment of the present disclosure.

Referring to FIG. 5, in Step S510, the network device transmits reference signal information to a user equipment. The reference signal information includes information related to a plurality of first reference signals. The information related to the plurality of first reference signals may be used by the user equipment to determine a parameter of a second reference signal. For example, the information related to the plurality of first reference signals may be used by the user equipment to determine the parameter of the second reference signal using an artificial intelligence model.

As mentioned above in describing the wireless communication method performed by the user equipment, the types of the plurality of first reference signals may be same or different. In addition, the information related to the plurality of first reference signals may include one or more TCI states. According to an exemplary embodiment, the information related to the plurality of first reference signals may be used by the user equipment to determine the parameter of the second reference signal based on a correlation between the first reference signal and the second reference signal. Here, the correlation may include a spatial domain correlation or a spatial frequency domain correlation.

For example, each of the plurality of first reference signals has the same correlation with the second reference signal; or, the correlation between the first reference signal and the second reference signal is related to an order of the first reference signal and/or a weight of the first reference signal. According to an exemplary embodiment, the wireless communication method shown in FIG. 5 may also include transmitting an indication of weights of the plurality of first reference signals to the terminal equipment, where the weight is related to the correlation between the first reference signal and the second reference signal.

Alternatively, the wireless communication method shown in FIG. 5 may further include transmitting an instruction of frequency domain information of the first reference signal and/or frequency domain information of the second reference signal to the terminal equipment, where the correlation may be related to the frequency domain information of the first reference signal and/or the frequency domain information of the second reference signal.

Alternatively, the wireless communication method shown in FIG. 5 may also include transmitting a first indication information of a spatial domain correlation or a spatial frequency domain correlation to the user equipment. The first indication information may be used to instruct the user equipment to determine the parameter of the second reference signal based on the spatial domain correlation or spatial frequency domain correlation between the first reference signal and the second reference signal.

Alternatively, the information related to the first reference signals may be used by the user equipment to determine the parameter of the second reference signal based on at least one of the first reference signals.

According to an exemplary embodiment, the at least one of the first reference signals may be a part of the plurality of first reference signal determined according to an order and/or measured values of the plurality of first reference signals.

Since the reference signal information, the first reference signal, the second reference signal and the correlation involved in FIG. 5 have been introduced in the description of FIG. 4 above, so it will not be repeated here.

According to the wireless communication method in FIG. 5, since the network device may transmit the reference signal information to the user equipment (the reference signal information includes the information related to the plurality of first reference signals), it is convenient for the user equipment to determine the parameter of the second reference signal according to the information related to the plurality of first reference signals, thereby reducing the delay and improving the receiving performance.

The above has described the wireless communication method performed by the user equipment and the network device respectively according to the exemplary embodiments of the present disclosure. Below, the user equipment and the network device are briefly described.

FIG. 6 is a block diagram of a user equipment according to an exemplary embodiment of the present disclosure.

Referring to FIG. 6, a user equipment 600 may include at least one processor 601 and a transceiver 602. Specifically, the at least one processor 601 may be coupled to the transceiver 602 and configured to perform the wireless communication method mentioned in the above description of FIG. 4. The details of the operations involved in the above wireless communication method are described in FIG. 4 and will not be repeated here.

FIG. 7 is a block diagram of a network device according to an exemplary embodiment of the present disclosure.

Referring to FIG. 7, a network device 700 may include a transceiver 702 and at least one processor 701. Specifically, the at least one processor 701 may be coupled to the transceiver 702 and configured to perform the wireless communication method mentioned in the above description of FIG. 5. The details of the operations involved in the above wireless communication method are described in FIG. 5 and will not be repeated here.

At least one of the above multiple modules may be implemented by an AI model. Functions associated with AI may be performed by a non-volatile memory, a volatile memory, and a processor.

The processor may include one or more processors. At this time, one or more processors may be general-purpose processors such as central processing units (CPUs), application processors (APs), etc., processors only used for graphics such as graphics processors (GPUs), vision processors (VPU), and/or AI-specific processors such as neural processing units (NPUs).

One or more processors control processing of inputting data according to predefined operating rules or artificial intelligence (AI) models stored in the non-volatile memory and the volatile memory. The predefined operating rules or the artificial intelligence models may be provided through training or learning. Here, providing by learning means that by applying a learning algorithm to a plurality of learning data, a predefined operating rule or AI model with desired properties is formed. Learning may be performed in an AI executing device itself according to an embodiment, and/or may be implemented by a separate server/device/system.

A learning algorithm is a method of using a plurality of learning data to train a predetermined target device (e.g., a robot) to cause, allow or control the target device to make a determination or prediction. Examples of the learning algorithm include, but are not limited to, supervised learning, unsupervised learning, semi-supervised learning, or reinforcement learning.

An AI model may be obtained by training. Here, “obtained by training” refers to training a basic artificial intelligence model with a plurality of training data through a training algorithm, thereby obtaining a predefined operating rule or artificial intelligence model configured to perform required characteristics (or purposes).

As an example, an artificial intelligence model may include a plurality of neural network layers. Each of the plurality of neural network layers includes a plurality of weight values, and neural network calculation is performed by a calculation between calculation results of a previous layer and the plurality of weight values. Examples of neural networks include, but are not limited to, convolutional neural networks (CNN), deep neural networks (DNN), recurrent neural networks (RNN), restricted boltzmann machines (RBM), deep belief networks (DBN), bidirectional recurrent deep neural networks (BRDNN), generative adversarial networks (GAN), and deep Q-networks.

According to an embodiment of the present disclosure, a computer readable storage medium storing a computer program is also provided. The computer program, when executed by at least one processor, causes the at least one processor to perform the above various wireless communication methods according to the exemplary embodiments of the present disclosure. Examples of computer-readable storage media herein include: Read Only Memory (ROM), Random Access Programmable Read Only Memory (RAPROM), Electrically Erasable Programmable Read Only Memory (EEPROM), Random Access Memory (RAM), Dynamic Random Access Memory (DRAM), Static Random Access Memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blue-ray or optical disk storage, Hard Disk Drive (HDD), Solid State Drive (SSD), card storage (such as multimedia cards, secure digital (SD) cards or extremely fast digital (XD) cards), magnetic tapes, floppy disks, magneto-optical data storage devices, optical data storage devices, hard disks, solid state disks, and any other devices that are configured to store computer programs and any associated data, data files and data structures in a non-transitory manner and provide the computer programs and any associated data, data files and data structures to a processor or computer so that the processor or computer can execute the computer programs. The instructions or computer programs in the computer-readable storage medium described above may be executed in an environment deployed in a computer device. In addition, in one example, the computer programs and any associated data, data files, and data structures are distributed on a networked computer system, so that the computer programs and any associated data, data files, and data structures are stored, accessed and executed through one or more processors or computers in a distributed manner.

Other embodiments of the present disclosure may readily be conceived by those skilled in the art upon consideration of the specification and practice of the invention disclosed herein. This application is intended to cover any variations, uses, or adaptations of the present disclosure that follow the general principles of the present disclosure and include common knowledge or techniques in the technical field not disclosed by the present disclosure. The specification and examples are to be regarded as exemplary only, with the true scope and spirit of the disclosure being defined by the claims.

1. A communication method by a user equipment, the method comprising:
receiving, from a network device, reference signal information, wherein the reference signal information comprises information related to a plurality of first reference signals;
determining a parameter of a second reference signal according to the information related to the plurality of first reference signals.

2. The communication method according to claim 1, wherein,
types of the plurality of first reference signals are same or different.

3. The communication method according to claim 1, wherein,
the information related to the plurality of first reference signals comprises one or more transmission configuration indication (TCI) states.

4. The communication method according to claim 1, wherein the determining the parameter of the second reference signal comprises:
determining the parameter of the second reference signal according to a correlation between the first reference signal and the second reference signal.

5. The communication method according to claim 4, wherein,
correlations between each of the plurality of first reference signals and the second reference signal are same; or
the correlation between the first reference signal and the second reference signal is related to an order of the first reference signal or a weight of the first reference signal.

6. The communication method according to claim 1, further comprising:
receiving an indication of weights of the plurality of first reference signals, wherein the weight is related to a correlation between the first reference signal and the second reference signal.

7. The communication method according to any one of claim 4, wherein
the correlation comprises a spatial domain correlation or a spatial frequency domain correlation.

8. The communication method according to claim 1, wherein the determining the parameter of the second reference signal according to the correlation between the first reference signal and the second reference signal comprises:
determining the parameter of the second reference signal according to a spatial domain correlation or a spatial frequency domain correlation between the first reference signal and the second reference signal, based on a first indication information about the spatial domain correlation or the spatial frequency domain correlation transmitted by the network device; or
determining the parameter of the second reference signal according to the spatial domain correlation between the first reference signal and the second reference signal; or
determining the parameter of the second reference signal according to the spatial frequency domain correlation between the first reference signal and the second reference signal.

9. The communication method according to claim 4, further comprising:
receiving an indication of frequency domain information of the first reference signal or frequency domain information of the second reference signal, wherein the correlation is related to the frequency domain information of the first reference signal and/or the frequency domain information of the second reference signal.

10. The communication method according to claim 1, wherein the determining the parameter of the second reference signal comprises:
determining at least one first reference signal according to information of the plurality of first reference signals,
determining the parameter of the second reference signal according to the at least one first reference signal.

11. The communication method according to claim 10, wherein,
the user equipment determines the parameter of the second reference signal according to a part of the plurality of first reference signals based on a first condition.

12. The communication method according to claim 11, wherein the first condition comprises at least one of:
the user equipment does not have a capability to determine the parameter of the second reference signal according to the plurality of first reference signals;
the user equipment supports determining the parameter of the second reference signal according to a first number of first reference signals at most, wherein the first number is less than the number of the plurality of first reference signals;
a scenario where the user equipment is located is different from a scenario applicable for determining the second reference signal according to the plurality of first reference signals;
a measured value of a parameter of a reference signal determined by the user equipment according to the plurality of first reference signals is lower than a measured value of the parameter of the reference signal determined according to one of the plurality of first reference signals.

13. The communication method according to claim 11, wherein,
the part of the plurality of first reference signals is a part of first reference signals determined according to an order and/or measured values of the plurality of first reference signals.

14. The communication method according to claim 1, wherein the determining the parameter of the second reference signal comprises:
determining the parameter of the second reference signal by using an artificial intelligence model.

15. A user equipment, comprising:
a transceiver;
at least one processor coupled to the transceiver and configured to control to:
receive, from a network device, reference signal information, wherein the reference signal information comprises information related to a plurality of first reference signals, and
determine a parameter of a second reference signal according to the information related to the plurality of first reference signals.
